(19) United States
(12) Patent Application Publication
(10) Pub. No.: US 2006/0287004 A1
(43) Pub. Date: Dec. 21, 2006

(54) SIM card cash transactions

(76) Inventor: Walter B. Fuqua, Albuquerque, NM (US)

Correspondence Address: CARSTENS & CAHOON, LLP, P O BOX 802334, DALLAS, TX, 75380, US

(21) Appl. No.: 11/155,356

(22) Filed: Jun. 17, 2005

(51) Int. Cl. H04B 1/38

(52) U.S. Cl. 455/558

(57) ABSTRACT

The present invention provides a mobile device such as a cellular phone or PDA that can store and transfer electronic currency, similar to a debit card. Specifically, the mobile device includes a transceiver for wireless near field communication (NFC) and a subscriber identity module (SIM), wherein the SIM maintains a balance of electronic currency units that represent specified monetary values. The SIM is able to directly exchange electronic currency units with second party devices via the NFC transceiver without having to connect to a wireless communications network, wherein the SIM tracks and adjusts said balance of currency units during an exchange.

### TECHNICAL FIELD

The present invention relates generally to telecommunications and, more specifically to a method and system for conducting financial transactions over a wireless communications and handheld wireless devices.

### BACKGROUND OF THE INVENTION

Wireless service providers provide communications services between a mobile unit, e.g., wireless phone, Personal Data Assistant (PDA), BlackBerry, computer, etc., and another party using another wireless device or a non-wireless terminal in which a voice call can be terminated to a land based telephone or other device such as a computer, POS terminal, ATM machine or OS computer terminal. Generally, the mobile unit communicates with a wireless network via a wireless communications protocol such as Code Division Multiple Access (CDMA), Time Division Multiple Access (TDMA), Global System for Mobile communications (GSM), General Packet Radio Service (GPRS), etc. The wireless network in turn provides connectivity to the telecommunications network, which typically comprises switches interconnected by cables or fiber and provides communications services to the other user.

As the proliferation of wireless services has expanded, so have the types of service offerings to reach different market segments. One such service is the use of mobile units like cell phones and PDAs for storing electronic cash that can be used for purchases, e.g., vending machines, gas stations, convenience stores. However, in the current art this new capability is provided by special data cards (e.g., flash memory) inserted into the mobile phone or PDA. This card stores the user's identifying information and the amount of funds available in the user's account.

This innovation requires not only the purchase of the data card itself but in some instances the user may also be required to purchase a new mobile unit that can accommodate such a card. As of the time of this writing the total purchase price of such a flash card and phone or PDA is about $100 US. When one considers that there are currently 1.8 billion mobile phones in service around the world, the conversion cost of incorporating this new technology into the existing marketplace is staggering.

Therefore, it would be desirable to have a mechanism that provides the ability to store and transfer currency electronically on pre-existing mobile devices such as cellular phones and PDAs.

### SUMMARY OF THE INVENTION

The present invention provides a mobile device such as a cellular phone or PDA that can store and transfer electronic currency, similar to a debit card or Stored Value Card. Specifically, the mobile device contains a subscriber identity module (SIM) card that includes computer program code for retrieving from memory an available balance of electronic currency units that the mobile device is authorized to transfer to second parties. The mobile device is allowed to transfer a specified number of currency units to a second party, wherein the specified number of currency units is less than or equal to the available balance stored on the SIM card. The amount of transferred currency units is then deducted from the available balance that is stored on the SIM card in the wireless handset.

The mobile device has the ability to transfer a specific number of currency values to a corresponding wireless device similarly equipped, thereby allowing one user of this technology to transfer funds directly to another user. This process, commonly known as a remittance, can be completed by transferring available funds from one phone to another phone without the intervention of external companies who normally offer remittance services for a fee. The capability of the phone to transfer funds from one phone to another will aid the user in sending small amounts of money to friends or family who are in need of money quickly or are far away from the sender.

Additionally, the present invention enables the user to make payment to third parties, whom the user may be obligated to pay or remit a payment by means other than directly to the mobile device, allowing the user to forward payment to the intended party via an authorization to pay from available funds held in the phone. This feature is commonly known as bill paying. The methods most commonly used by consumers to pay bills have been bank check, bank draft, or authorization for electronic transfer of funds to creditors. The “bill pay” feature of this invention allows safe and secure authorization and transfer of funds to the intended party.

The invention further allows for micro-payments used in retail transactions between the phone user and a merchant to conduct a cash type transaction, and further allow for macro-payments where the phone user has the need to forward money to a creditor for which a debt is owed and the phone user wishes to pay such obligation from the available funds on the phone.

The present invention allows the SIM device to hold currencies in different values and provides separate partitions in the SIM card that let the user store funds from different national currency denominations, allowing the representative values of the different currencies to be held on the SIM simultaneously.

An algorithm allows the temporary conversion of currency from one basis to another (without causing the actual conversion and exchanging of foreign currency) until such time as when the user is in need of the funds to be delivered in the desired currency indigenous to the user's physical location.

In one embodiment of the present invention, fund transfers are conducted offline via RFID near field communication.

In another embodiment of the present invention, the SIM chip has a corresponding plastic card similar to a standard credit card. This plastic card contains the same identification and account information as the SIM and allows the user to transact business with merchants that are not equipped to interface with the SIM card in the mobile device, without the user having to maintain a separate credit card account.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 depicts a telephony network in which the present invention may be implemented and the specific path of secure data transmission critical to the overall operability and function-ability;

FIG. 2 is a flowchart of the steps used to configure a mobile unit in accordance with the present invention;

FIG. 3 is a flowchart illustrating the steps of activating or re-activating a mobile unit for financial services;

FIG. 4 is a flowchart showing the process of converting base funds into tokens or foreign currency;

FIG. 5 is a flowchart illustrating the steps of utilizing a mobile unit for financial transactions in accordance with the present invention;

FIG. 6 is a flowchart depicting the process of maintaining and updating accounts on the prepaid financial application server; and

FIG. 7 is a flow chart that depicts the communication between the receiving device and the cellular device for the purpose of completing an electronic financial transaction.

### DETAILED DESCRIPTION OF THE DRAWINGS

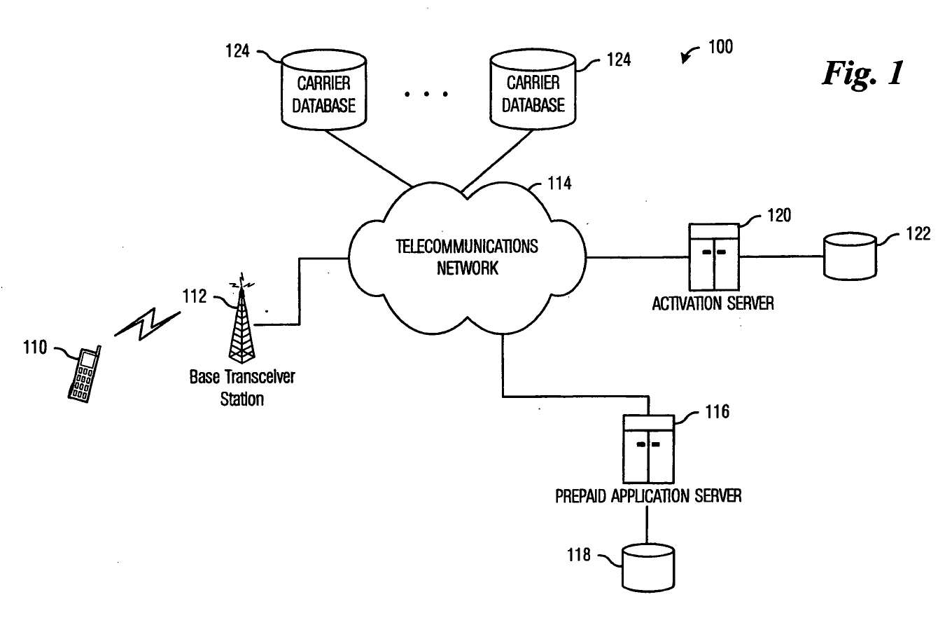

FIG. 1 depicts a telephony network in which the present invention may be implemented. It should be noted that those skilled in the art will recognize that the network 100 has been simplified to better illustrate features of the present invention. The network 100 comprises a mobile unit 110, a base transceiver station (BTS) 112, a telecommunications network 114, a prepaid financial services application server 116, a prepaid financial application database 118, an activation server 120, an activation database 122, and one or more carrier databases 124.

The mobile unit 110 is configured to communicatively couple to the BTS 112, preferably via a wireless communications protocol such as GSM, CDMA, TDMA, GPRS, or the like. In addition, the mobile unit 110 is preferably configured to accept a subscriber identity module (SIM) card having a wireless prepaid application for financial services stored thereon (described in more detail below). The mobile unit 110 may be any suitable access device that may be configured to communicate via a telecommunications network 114, such as a mobile phone, laptop computer, tablet personal computer, PDA, BlackBerry, etc. However, for purposes of simplicity, the present discussion will primarily use the example of a mobile phone.

The BTS 112 is communicatively coupled to the telecommunications network 114, which may comprise wire and wireless network elements. The telecommunications network 114 may be, for example, a network such as the Internet, a local-area network (LAN), a wide-area network (WAN), a direct connection, a Public-Switched Telephone Network (PSTN), a wireless communications network, or the like.

The prepaid financial application server 116 provides registration and operational management functions for the wireless financial services and is communicatively coupled to a prepaid financial application database 118 that provides storage capabilities. It should be noted that the prepaid financial application server 116 is illustrated as a single component for illustrative purposes only and may comprise one or more servers and network elements. Furthermore, the prepaid application database 118 may be a stand-alone database system or integrated into the prepaid application server 116. The prepaid application database 118 may comprise an electronic storage medium such as a hard disk, tape storage, optical disks, memory, a storage area network (SAN), etc.

The activation server 120 and activation database 122 provide mobile unit activation/deactivation capabilities for the wireless prepaid application. Generally, a mobile unit 110 is identified by one or more unique identifiers. In one embodiment, the mobile unit 110 is identified by the combination of International Mobile Equipment Identifier (IMEI), a SIM card International Mobile Subscriber Identity (IMSI), and a phone number. The activation server 120 and activation database 122 are maintained by a third party. One such third party is GEMPLUS, located in Dallas, Tex., which provides an activation/deactivation interface between the prepaid financial application server 116 and the carrier databases 124.

The carrier databases 124 represent the wireless service providers' databases of active mobile units (i.e. mobile unit 110). Generally, each wireless service provider (not shown) only allows mobile units that have been authorized or activation to place or receive telephone calls. Thus, the wireless prepaid financial application can control the ability of the mobile unit 110 to place or receive calls by modifying (or instructing the wireless service provider to modify) the status of the mobile unit 110 in the appropriate carrier database 124. Likewise (as discussed in more detail below) the ability of the mobile unit 110 to use different wireless service providers' networks may be controlled by modifying each wireless service provider's carrier database 124 independently.

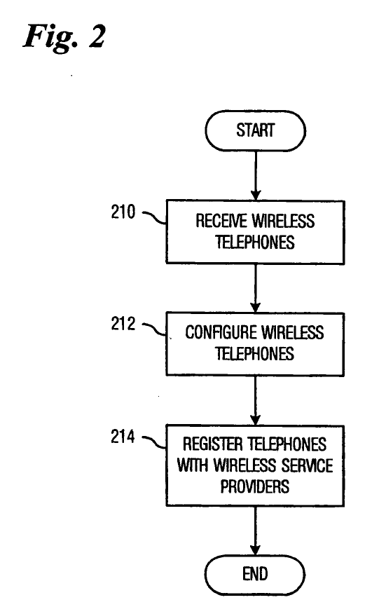

FIG. 2 is a flowchart of the steps used to configure a mobile unit in accordance with the present invention. The process begins when the mobile units are received from the manufacturer (step 210). Generally, manufacturers produce the mobile units and sell them in quantity to wholesalers. At this point, the mobile units are not configured for operation, and hence, must be properly configured prior to being used.

Each mobile unit is preferably identified by one or more unique identifiers. In one embodiment of the present invention, each mobile unit is uniquely identified by the IMIE and a telephone number. Each mobile unit is further identified by the SIM card number (IMSI) in combination with an IMIE and phone number (ANI) (step 212).

The unique identifier (which may be a singular number or combination of numbers) is then registered with the carrier database (step 214). In one embodiment, the registration process includes registering the unique identifier with the prepaid financial application server (FAS) and database. The registration of the unique identifier with the prepaid FAS allows the wireless prepaid service to manage the available funds of the mobile units, detect fraudulent activities, and provide other customer services, as described in detail below.

Furthermore, the registration process described above may utilize an activation service, which provides an interface between the wireless prepaid service provider and the wireless network service provider. In this embodiment, the prepaid application server may notify the activation server of the unique identifier and request that the corresponding mobile unit be authorized for use with one or more service providers. The activation server preferably stores the activation request information in the activation database and transmits a request to one or more carrier databases. Thereafter, the mobile unit is capable of placing and receiving wireless service.

All requests made from the handset will require authentication of the unique identifier (International Mobile Equipment Identity (IMEI), International Mobile Subscriber Identity (IMSI), and/or assigned phone number) of the requesting handset, a trace ID number, and beneficiary information. Part of the authentication process includes the user creating a unique PIN code that must be used to validate the user's request for a financial transaction or funds transfer. Without the proper PIN validation code to authenticate the user request, the transaction request will be denied and a message will be sent to the phone, notifying the user that an attempt to complete a transaction was denied due to invalid PIN entry. As a further possible security feature the user may attempt to enter the valid PIN up to, e.g., three times, and then the SIM will lock the funds on the phone until the user contacts the customer care center and verifies that he is in possession of the handset and by validating a password, the phone's financial features will be unlocked for use by the authorized user.

It should be noted that the registration process describe above assumes that multiple companies must coordinate their respective activities in order to provide the wireless prepaid financial services. For example, the mobile units are provided by a first company, the wireless services are provided by a second company, the wireless prepaid financial service is administered by a third company, and the activation interface is provided by a fourth company. Under different structures, the basic registration process described above may remain intact, but some steps and network elements may be combined. For example, the prepaid financial application server may communicate directly with the carrier database, thereby eliminating the need for the activation server.

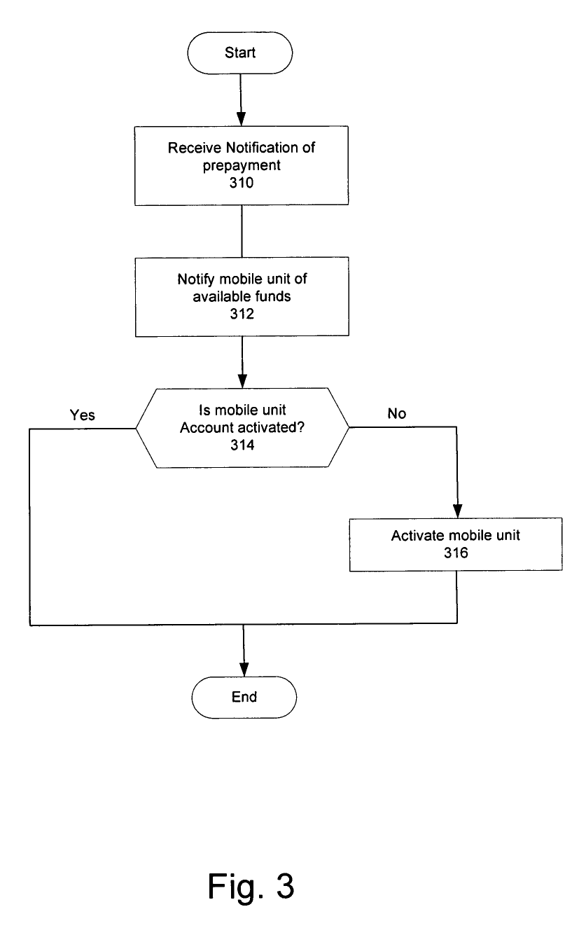

FIG. 3 is a flowchart illustrating the steps of activating or re-activating a mobile unit for financial services. The prepayment and subsequent loading of electronic cash is preferably a specified amount and equivalent value being loaded onto the cellular device. The currency units may be based upon any currency value (e.g., pennies, nickels, dimes, and dollars) denoted as US currency or the equivalent thereof in foreign currency. In one embodiment, a user prepays for a certain amount of currency he wishes to store as value on the cellular device. This is typically referred to as a base denomination in local currency, wherein the user pays for a number of electronic tokens that represent the cash equivalent of funds the user wishes to store on the cellular device, regardless of when the use occurs.

The process begins when notification of prepayment is received (step 310). The user may prepay via a variety of methods. For example, the user may prepay by sending a check to the service provider requesting that the check be applied to the user's account. The user may also contact the wireless service provider via phone or Internet connection and prepay using a credit or debit card. In a preferred embodiment of the present invention, the user is provided with one or more menus on the mobile unit itself, which allows the user to request the service provider to extract payment from the credit/debit card on file.

In one embodiment, the user may purchase the mobile unit from a vendor and dial a predetermined number, which is associated with a particular vendor, service special, or other marketing program. Once dialed, the user is connected to a customer service representative or automated system through which the user is able to prepay for services.

Activation of the financial features requires the financial service provider to make a positive identification of the user who wishes to place fund on the cellular handset. This also can be achieved by the user making a personal appearance at an authorized dealer and providing acceptable Identification and choosing a PIN number to activate and authorize any future purchases, payments or transfers using the funds available on the cellular handset.

After the prepaid financial service provider has received notification of receipt of good funds at any authorized merchant or payment at the offices of the financial services provider, the mobile unit is notified of the availability of electronic tokens or cash equivalent (step 312). This may be accomplished with a short-message service (SMS) message from the prepaid financial application server to the mobile unit. In the preferred embodiment, the mobile unit itself (more specifically, the SIM card) tracks the number of electronic units (tokens) available so as not to require the mobile unit to access the telecommunications network and application service and maintain a connection during each use, thereby removing the need for additional ports and resources. In some cases the mobile unit may not have the capability to complete a financial transaction at this time. In such a case the prepaid financial application server verifies and completes the process to validate a request from a handset to any intended recipient.

After the mobile unit is notified and updated regarding available funds, the activation server determines whether or not the account associated with the mobile unit is activated (step 314). For example, if the mobile unit is new the financial account needs to be activated after the first deposit of funds is received. In the case of a preexisting account, a mobile unit may have been deactivated when the previous balance of funds was exhausted.

If the mobile unit account is not yet activated (or has been previously deactivated), the activation server enters the unit's unique identifier into the prepaid financial service database to reflect an active account (step 316).

If a determination is made that the mobile unit is already activated, the activation process simply ends.

The SIM card can display all balances in any section where currency and tokens are stored. This feature allows the user to manage balances in real time and prepare for upcoming expenditures accordingly. All transactions will be recorded in the Financial Application Server and the most recent transactions (e.g., five) will be stored on the SIM card for display on the device screen.

The present invention places partitions on the SIM card that are able to store units of measure (UOM) and deduct those UOM automatically or manually, based on commands entered on the handset keypad. The partitions can be identified as files to store various UOM (e.g., currency, tokens, time units). For example, the SIM card may have a file for each country. The user can purchase currency to be used while traveling to a single country. This will allow the user the flexibility of taking advantage of preserving favorable exchange rates or locking in short term exchange rates while traveling, and pre-purchasing electronic tokens to obtain discounts or for ease of payment at a collection point. Another example is the storage of different national currencies in different SIM card partitions.

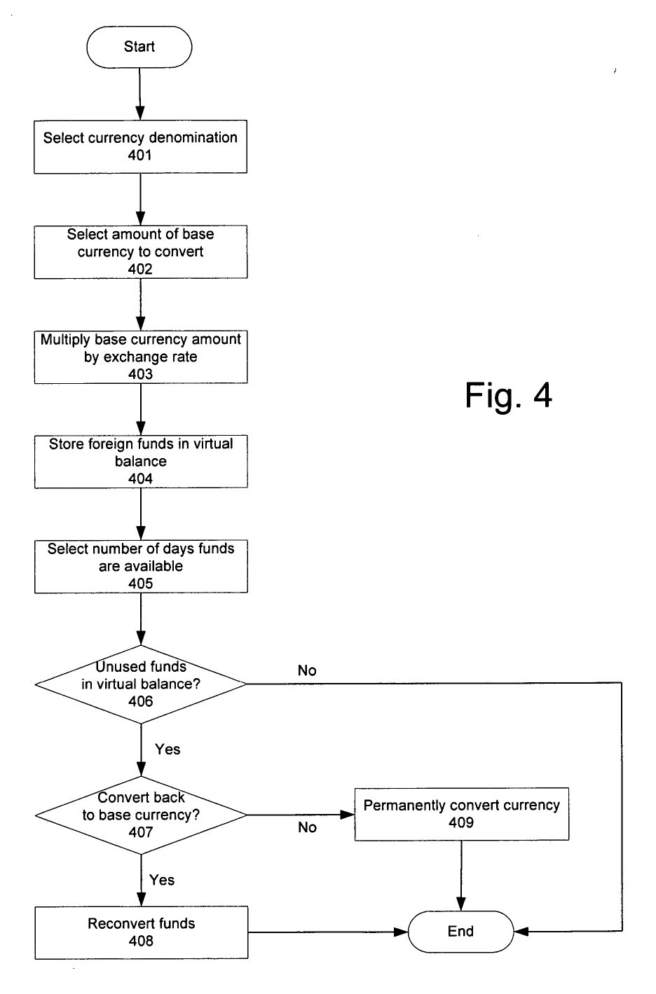

FIG. 4 is a flowchart showing the process of converting base funds into tokens or foreign currency. When funds are initially loaded onto a phone or other mobile device as described above, these funds are denominated in a base currency. The base currency is determined by the locality in which the user has registered the cellular handset, with all other currencies stored on the SIM card designated as foreign currency. A portion (or all) of this base currency can be converted to other currencies. The present example will use U.S. dollars as the base currency.

The user selects the specific foreign currency into which he would like to convert the base currency (step 401). The user then selects the amount of based currency to be converted (step 402). This amount of base currency units is multiplied by the official exchange rate between the two currencies, which changes daily (step 403). The funds are then placed into a virtual balance, which is a partition in the SIM card (step 404).

A variable currency valuation and exchange may be implemented when the mobile unit is detected in a foreign country where the user may choose to have currency values converted into the local currency. The user may choose to convert any portion of funds available on the handset to the local currency at a predetermined prevailing exchange rate determined on the day the user requests to convert funds. These converted currencies bear the equivalent value of the funds converted, less any foreign currency exchange fees paid. The exchange rate will vary depending on the time of day and be based on intraday exchange rates published by the central bank.

The user can view the net revaluation in this local currency. The request for currency exchange may be accomplished by the mobile unit and/or the SIM card. This is accomplished by tracking the dollar amount available and the established exchange rate contracted for and posting to the user's handset display screen the amount of local currency the user will receive in the exchange and conversion to the local currency.

The user then selects the number of days (e.g., 5, 7, or 10) he would like to have these foreign funds available for use (step 405).

The virtual balance is not a settled currency exchange. Rather, it is similar to a futures contract that allows the user to access the specified amount of foreign currency as needed during the prescribed time period and pay an exchange fee for only the actual portion of funds used in a foreign country. This eliminates the exchange fee for reconverting unused foreign funds back to US currency (explained below).

At the end of the specified time period, a determination is made as to whether there are any unused foreign funds in the virtual balance (step 406). If there are unused foreign funds in the virtual balance, the user then has the option of reconverting those funds back into the base currency or permanently convert them to the foreign currency (step 407).

If the user decides to reconvert the remaining virtual balance, the currency units are merely recalculated back into the base currency at the exchange rate used in step 403 (step 408).

The user may decide to convert these foreign currency values to permanently converted funds held as a separate value in the cellular device (step 409). This step involves the final settlement of the virtual balance and any applicable exchange fees. The permanent foreign funds are held in a separate partition until such time as the user desires to spend, remit, or convert said foreign currency back to the base currency.

By placing separate partitions on the SIM card, the Financial Application Server can access a specific storage area of the SIM card to load funds (electronic currency (tokens)) in the national currency denomination the user desires to buy. The user may then keep foreign funds stored in their respective partitions until a time when the user is in a location where the currency can be used for payments. Therefore, a user can purchase and store foreign currencies in advance or when the exchange rate is favorable without being subject to spot exchange rates at the moment a transaction in local currency is desired.

The implementation of SIM partitions also allows the storage of currency equivalents for use in proprietary systems. For example, merchants, government municipalities, and other entities may accept electronic tokens for the purpose of payment for specific good and services within that proprietary system, e.g., toll booth and subway tokens, merchant coupons, amusement park tokens, etc. These may be established by the vendor and delivered to the financial application server for delivery to any user at the request of the user, thus facilitating the expedited settlement of payments between the merchant and the user. Any merchant tokens are defined as coupons, which are limited to uses as defined by the merchant's rules and regulations. The purchase and storage of any merchant coupons that are delivered to the SIM card are controlled and disbursed in the same fashion as all other funds.

The SIM card contains a dynamically controlled calculator that serves as the rate table for currency exchange services as well as fixed rate products that convert into electronic tokens for use in subways, parking meters, or anywhere a fixed rate token can be issued by a vendor which can be stored on the SIM card. The token can be passed to the issuing vendor as needed by the user at the time. The price of a token may be changed by remote control service by using Over-The-Air (OTA) commands that allow the calculator to recognize a new price structure for the purchase of a token from any vendor that may wish to sell their services via the direct payment methods employed in the present invention.

In addition to national currencies, the present invention can also be used with precious metal-backed electronic units provided by companies such as Goldmoney and e-gold. In this case, the electronic units stored on the SIM card are backed by precious metals on deposit rather than dollars, Euros, pounds, etc., and are denominated in units of weight (e.g. grams).

The storage of different currencies on a SIM card is also beneficial to users who regularly send money to family members abroad. In the case of international remittance, the present invention allows the payment of foreign funds to a second party without the sending party having to actually purchase foreign currency. In this case, the financial service maintains separate corporate accounts in both the sender's country and the recipient's country, each denominated in the respective local currencies. Because both accounts belong to the same company, there is no need to make an immediate international transfer when the sender remits payment to the recipient. Instead, the financial service is able execute a simple clearing operation that locally updates the respective accounts of the sender and recipient and the respective corporate account balances.

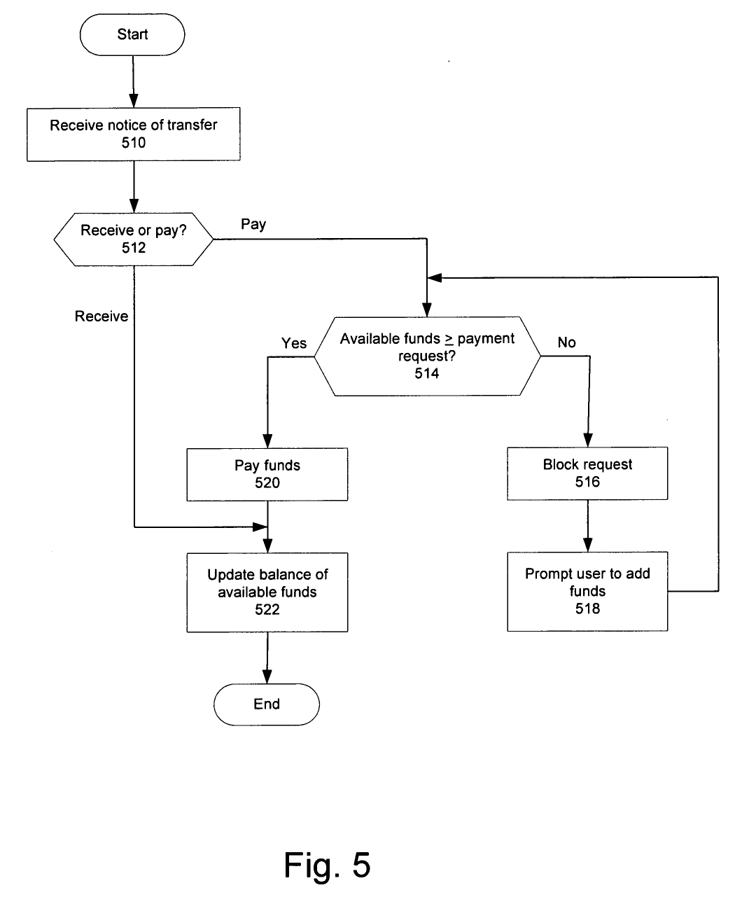

For example, if the sender lives in the U.S. and wishes to send the equivalent of $100 to a friend or family member in Mexico, the send merely has to execute a remittance to the recipient in the manner described below in relation to FIG. 5. The financial application server will then deduct the $100 from the sender's local account in the U.S. and adds this $100 to the U.S. corporate account balance. The server applies the current exchange rate to determine the appropriate number of Mexican pesos and transfers this amount from the Mexican corporate account balance to the recipient's personal account.

In-this way, an international transfer of funds does not have to be made for each individual remittance. Rather, the individual transfers are cleared against the respective national corporate account balances. The final settlement and transfer of payments can be made between the U.S. and Mexican corporate accounts at designated intervals (e.g., end of day, end of week, etc.). This provides tremendous advantages and cost savings with regard to currency exchange fees. Because the corporate accounts are being settled rather than the individual user accounts the amount of funds being exchanges is much greater (e.g., $1 million versus $100). This allows the financial service to take advantage of lower exchange fees that the individual users cannot. For example, instead of incurring a 3% exchange fee for an individual transfer and adding another 3% service fee, the financial service can get a 1% exchange fee for the clearly house settlement and charge the customer only the 3% service fee.

FIG. 5 is a flowchart illustrating the steps of utilizing a mobile unit for financial transactions in accordance with the present invention. The process begins when the SIM card receives notification of a request for payment or reception of funds (step 510).

Upon receipt of the request, a determination is made whether the request is for the reception or payment of funds (step 512). For example, a payment may be to a merchant, to another cellular device, to a second party for payment of any debt or bill, or a deposit to an ATM. Reception of funds may be from another mobile unit, from a specially equipped ATM, or from customer service to reflect additional funds added by the user.

If the transaction is for the addition of funds to the mobile unit, the mobile unit simply updates the balance of available funds on the SIM card to reflect the additional amount (step 522).

If the transaction is for a payment, a determination is made as to whether or not the SIM card has sufficient funds available to fulfill the payment request (step 514).

If sufficient funds are not available, the request is rejected (step 516), and the device will prompt the user to add more funds (step 518). The user may view the available balance at any time by performing a simple balance request command from the handset.

All calls to the customer service center are allowed to be made directly from the phone regardless of the availability of minutes or phone deactivation, thus allowing a user to recharge a phone for continued use or to add funds to the mobile unit.

If the available funds on the SIM card are greater than or equal to the amount of the payment request, the mobile unit transfers the funds to the recipient (step 520), and the SIM card updates the balance of available currency units by subtracting the amount of the payment from the available funds balance of the mobile unit (step 522).

In one embodiment of the present invention, the depletion of currency units triggers text and/or audio warnings to the subscriber, similar to a low battery warning. The warnings may indicate the remaining currency units available and preferably are given at set denominations (e.g., $10 remaining, $5, $1). These features help the user to manage the account of funds available on the mobile unit.

The means of communicating the necessary data to complete any transaction include wireless communication, internet protocol, WiFi internet protocols, WiMax, standard internet commerce methods, RFID read/write technology, and SMS messaging. In the case of transfers between two mobile units, the transfer may be completed by infrared communications, Bluetooth or other near field communications methods.

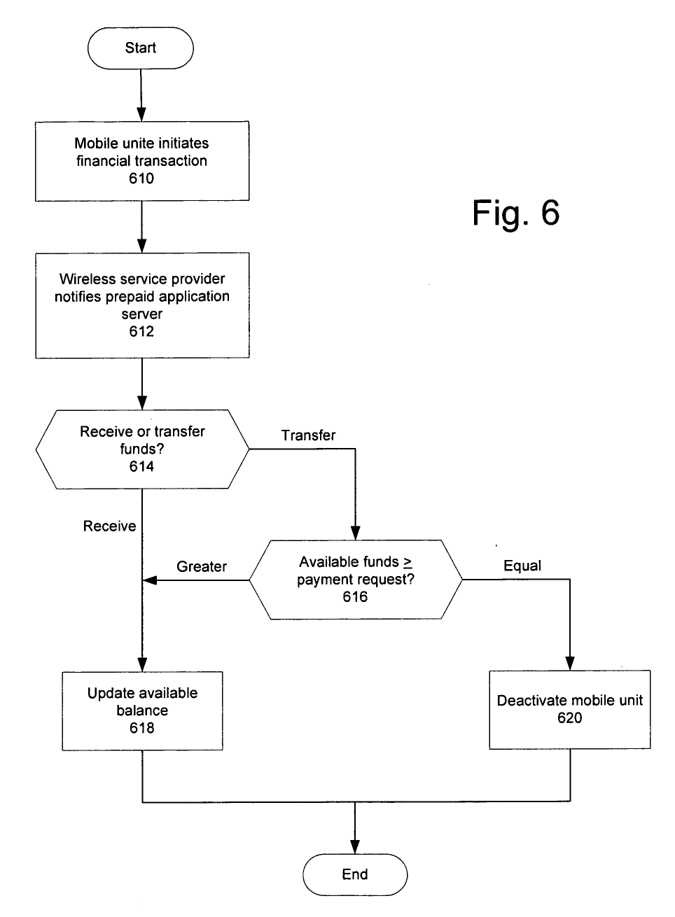

FIG. 6 is a flowchart depicting the process of maintaining and updating accounts on the prepaid financial application server. The process begins when the mobile unit makes any financial transactions using funds stored on the SIM card (step 610). Upon completion of the transaction, the wireless service provider (WSP) notifies the prepaid financial application server (FAS) of any request from the mobile unit to transfer funds to a merchant, withdraw money from an ATM, transfer or receive funds to/from another mobile unit, pay a bill, etc. (step 612). The notification from the WSP to the FAS may be by means of any suitable communications protocol such as Ethernet or IP message transmitted via the Internet. Because the message is only sent once, after completion of the transaction, there is no need to maintain a connection to the FAS prior to, during, or after the transaction.

The FAS then determines whether the transaction is for the reception or transfer of funds (step 614). If the mobile unit is receiving funds (from an ATM, another mobile device, or customer service) the received funds are simply added to the available balance of the account (step 618).

If the transaction is for the payment of funds, the FAS determines if the balance of funds available for the SIM card in question is greater than or equal to the requested funds transfer (step 614). If the available funds are greater than number of electronic tokens paid in the transfer, the FAS updates the user account to reflect the amount of authorized funds remaining (step 618).

If the payment is equal to the available balance, and hence exhausts the available funds for that account, the mobile unit is deactivated by deactivating the entry for the mobile unit in the FAS database (step 620). By deactivating the FAS account the SIM IMSI in question will be blocked from any further ability to transfer funds until such time as when the user reactivates the SIM card's financial features by loading more funds onto the phone. Until such time as the new funds are made available on the SIM card, the FAS will not allow the mobile unit to utilize its services. The account may be reactivated through the process shown in FIG. 3 by adding funds through customer service or by direct deposit of funds to the mobile unit from another mobile unit or ATM.

It should be noted that the FAS does not have to account for payments that exceed the balance of available funds, as any such attempted overdraft is blocked locally by the SIM card.

The embodiments described above thus maintain a funds available account on both the mobile unit (SIM card) and the prepaid financial application server. The mobile unit tracks the remaining available funds prior to, during, and after a transaction. The prepaid financial application server, on the other hand, maintains an account of the remaining available funds and records all transaction details once they are completed. This dual accounting approach allows the tracking of available funds to be handled primarily by the mobile unit, thus allowing the prepaid financial application server to be used for other activities such as identifying fraudulent activity.

While the FAS controls the SIM chip financial account, the functions for using the available funds are controlled by the SIM chip itself, thereby localizing the contact point of the SIM chip to a Point of Sale (POS) device.

To achieve a handset communication portal, an external RFID device which has an embedded Near Field Communications (NFC) sensor is attached to the mobile unit in a fashion that provides a direct connection to the power supply of the mobile unit and allows access to the SIM chip. This attachment is achieved by placing the RFID device in a housing that fits snugly onto the base of the mobile unit and allows the RFID device to connect with the metal contacts located on the mobile unit.

This RFID housing provides for the retrofitting of mobile devices that do not incorporate RFID capabilities at the time of manufacture. The housing might be constructed of plastic, leather or other durable materials and have a design that allows the user to remove the RFID device at will. Good examples are removable cell phone cradles that clip onto belts as well as the “wallet” cases and holsters used to carry PDAs and BlackBerry devices. Since mobile devices are often carried in such holders, users may simply hold the device close to a POS while leaving the device in the cradle. or wallet. Such accessories provide ready designs that can easily be altered to incorporate the RFID device and allows for easy use. Furthermore, providing an external RFID NFC device that can be retrofitted to existing mobile units eliminates the need for replacing these units.

By connecting a RFID device in this manner, the SIM chip is able to transmit the information and allow the transfer of funds to any corresponding device that has matching RFID read/write technology imbedded or retrofitted. A key benefit of using the RFID Near Field Communications Sensor is the ability to conduct financial transactions offline. By allowing communication directly between the SIM chip and the POS or other RFID capable device, there is no need to log onto a wireless network during the transaction.

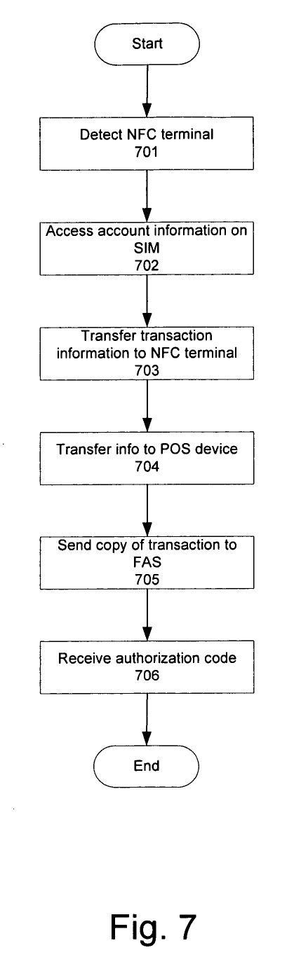

FIG. 7 is a flow chart that depicts the communication between the receiving device and the cellular device for the purpose of completing an electronic financial transaction. When the mobile unit is brought into range of a NFC equipped terminal, the RFID device on the unit detects the terminal (step 701). The RFID device then access the electronic currency account on the SIM card (step 702) and sends the necessary transaction information to the NFC terminal (step 703). This transaction information may include the mobile unit's International Mobile Equipment Identifier (IMSI), Automatic Number Identification (ANI), the user PIN, and the transaction balance.

The NFC terminal sends this information to the POS device (step 704). An electronic receipt is to the cellular device showing the summary details of the transaction just completed, and a full detailed copy of the transaction will be authenticated and sent to the Financial Application Server (step 705). The POS then obtains an authorization code from the FAS, which allows the POS complete use the transferred funds (step 706).

The actual movement of funds between the mobile unit and the POS is local via the RFID NFC devices, thereby completing the transfer of funds offline exclusively by near field communication methods and then going online in the network to deliver the message containing the details of the transaction to the FAS.

In one embodiment of the present invention, the operational path for processing a financial transaction starts by having the POS terminal deliver a message with details of the transaction to the FAS. A redundant SMS message is generated by the mobile unit and forwarded to the FAS the next time the mobile unit connects with a wireless network.

In an alternate embodiment of the invention, the mobile unit is the primary messenger of the transaction details to the FAS, with the POS device providing the redundant data message. This assumes that one of the two devices is a standard POS device currently employed in the field today.

In yet another embodiment of the invention, the transfer of funds can be between two mobile units and a similarly equipped with NFC devices. This allows the transfer of funds to occur between the two units (e.g., phones) while utilizing a wireless network to transmit transaction details via SMS back to the FAS. As with the POS transaction, the actual movement of funds between the two mobile units is conducted locally via the RFID near field communication devices, thereby completing the transfer of funds exclusively by near field communication methods and then going online in the network to deliver the SMS message containing the details of the transaction.

Therefore, RFID is used to add or retrieve funds to and from the SIM card, while the wireless carrier network is used to transport transaction data details to the financial application server to update the respective accounts.

Because each electronic currency unit (token) has a unique identifier, it is impossible to duplicate the tokens and counterfeit the electronic currency. In the case of the POS transaction above, when tokens are transferred from the cellular device, the unique identifiers for those tokens are erased from the SIM card account and are added to the POS account. When the transaction details are sent to the FAS, the association between the unique token identifiers and the respective accounts is updated to reflect the change in ownership. Therefore, the FAS has a record at all times as to which tokens belong to which account and SIM. If an attempt is made, for example, to duplicate electronic tokens onto a second SIM chip, the FAS will detect the discrepancy because it already knows that the token identifications in question already belong to another SIM.

The Financial Application Server randomly polls the SIM card to verify that the available balances and unique token identifiers match those stored on the Financial Application Server, in order to detect fraud and malfunctioning SIM cards. The FAS may disable the SIM card on a temporary or permanent basis. The disabling of a SIM card will require the authorized user to contact the service center for assistance in reactivating the SIM card or replacing the card entirely, and all verified balances will be reloaded onto any new SIM card.

In one embodiment of the present invention, the SIM card is also matched with a corresponding plastic payment card such as a credit card or bank card. This embodiment provides a solution for users attempting to make payments to merchants that do not possess the required technology to interact with a cellular device, without requiring the user to maintain a separate credit card account. The card can also be used to load additional cash onto the cellular device from any authorized merchant location.

The bank card possesses the capability to communicate via an embedded magnetic stripe or smart chip just like a standard credit card. The card contains the necessary information to allow the user to access the same data as the SIM card by swiping the card and allowing the merchant hardware to access the Financial Application Server for verification of funds which will be removed remotely from the SIM card by the Financial Application Server via over-the-air message and thereby transferred to the merchant.

The data that is critical to identifying a specific SIM chip is also embedded into the bank card equipped with the necessary format to interface with the standard bank electronic payment processing systems in use worldwide.

Standard bank cards use a 16-digit identification number, wherein the first four digits represent the Bank Identification Number (BIN) that identifies the issuing bank. Similarly, each SIM International Mobile Equipment Identifier (IMSI) uses a 16-digit identifier. However, the IMSI may include more than 16 digits and may also include letters, allowing for alpha-numeric identifiers.

The present invention incorporates the four-digit BIN of the bank card into the IMSI number and replaces the fixed number system of assigning a random number to a bank card by using the IMSI as the bank card number, thereby creating a permanent link between the dual cards.

By having the SIM and bank card cross referenced in this manner, a link is created between the SIM and the bank card, thereby allowing either the SIM or the bank card to access the financial network, which can identify the correct account regardless of the method used to access it (SIM or bank card).

The Financial Application Server acts as the host for accepting transaction requests from any receiving device that cannot accept a direct payment from the cellular handset device. Therefore, transaction requests from both the SIM chip and its corresponding plastic card go through the same Financial Application Server.

The financial transaction processing application employed by the present invention is based on standardized processes used in Electronic Financial Transaction Processing (EFTP) for all forms of consumer based electronic payment methods employed worldwide. The underlying structure uses the same merchant network to create the agents for loading currency units to the mobile unit as well as accepting payment for purchases made, using existing POS equipment and hardware. Therefore, introduction and use of the present invention does not require extensive reengineering or modifications to electronic financial systems currently in use.

By allowing a qualified merchant to accept funds from a consumer who wishes to add electronic tokens to a mobile phone, the invention effectively places these funds “on deposit” with the merchant, which can be used to offset any goods or services delivered by the same merchant to that customer during the course of each business day. The offset balance will be credited or debited to a merchant's account on a daily basis. All customer balances are reflected in real time transactions so that the consumer always has access to the funds, in both the loading and unloading of those funds on the mobile unit.

The total functionality of the present invention provides a set of services for which many people must seek different vendors to fulfill, e.g., cashing a paycheck, sending money abroad, buying money orders to pay bills, safely saving money for large purchases, and even recovering lost funds. Executing these functions through a mobile unit such as a cell phone lowers the associated risks and costs involved for the segment of society who live without bank accounts.

The present invention offers a safe alternative to consumers who may not have easy access to banks or even have the ability to open a bank account. These Un-banked individuals, whose numbers range from 20 to 40 million in the US and hundreds of millions worldwide, are familiar with cell phones, and most of these people may even have cell phones now. By allowing a Un-banked person to safely manage his or her finances from a cell phone or similar device, the present invention brings safety, security and identity to these many millions of people who now are faced with high costs to cash their checks, face the risk of carrying hard currency on their person in order to pay their bills, and have no effective way of managing their business affairs from one place.

The use and control of the SIM card to drive the process of managing financial transactions and the methodology of settlement between the consumer and merchant are the key elements for making a cell phone capable of being functional in the aspects of:

1. Storing electronic funds on the cell phone.

2. Delivery of any funds requested to the intended recipient.

3. Managing the movement of hard currency within the network and outside of the network.

Because the cash transaction functionality is provided through the SIM card, the present invention has the tremendous advantage of being backward compatible with existing mobile telephones.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A mobile electronic device for conducting financial transactions, comprising:
(a) a first transceiver for communication over wireless networks;
(b) a second transceiver for wireless near field communication; and
(c) a subscriber identity module (SIM), wherein the SIM stores electronic currency units that represent specified monetary values;
(d) wherein the SIM is able to directly exchange electronic currency units with second party devices via said second transceiver without having to connect to a wireless communications network;
(e) wherein the SIM tracks and adjusts the balance of electronic currency units before, during, and after an exchange.

2. The mobile device according to claim 1, wherein if the mobile unit receives a request to send electronic currency units to a second party device, the SIM card:
retrieves from memory the available balance of electronic currency units; and
fulfills the request only if the requested number of electronic currency units is less than or equal to the available balance.

3. The mobile device according to claim 1, wherein the monetary value of said electronic currency units may be converted from one type of currency to another.

4. The mobile device according to claim 1, wherein the SIM contains multiple partitions that enable the SIM to simultaneously store electronic currency units that represent different types of currency.

5. The mobile device according to claim 1, wherein a remote server maintains an account associated with the SIM and a record of the currency balance on the SIM, wherein the mobile device updates said balance record via said first transceiver after a currency exchange is completed.

6. The mobile device according to claim 5, wherein if the balance of electronic currency units on the SIM reaches zero, the SIM account is deactivated until additional electronic currency units are loaded onto the SIM.

7. The mobile device according to claim 1, wherein the mobile device may be one of the following:
mobile telephone;
personal digital assistant (PDA);
laptop computer; and
BlackBerry.

8. The mobile device according to claim 1, wherein the transceiver is contained in an external housing attached to the mobile device, wherein the housing allows the transceiver to connect to the SIM and power supply of the mobile device.

9. The mobile device according to claim 8, wherein the housing may be one of the following:
portable cradle for a belt clip;
carrying case.

10. The mobile device according to claim 1, wherein said second party devices may include:
point of sale machines;
automated teller machines (ATM);
mobile telephones;
personal digital assistants (PDA);
BlackBerries;
laptop computers; and
desktop computers.

11. The mobile device according to claim 1, wherein a separate bank card is associated with a financial account common to the SIM, and wherein the bank card can access the balance of electronic currency units stored on the SIM.

12. The mobile device according to claim 11, wherein the balance of electronic currency units on the SIM is updated by a remote server via over-the-air communication to account for financial transactions involving the bank card.

13. The mobile device according to claim 11, wherein the Bank Identification Number of the bank card is incorporated into the International Mobile Equipment Identifier of the SIM.

14. The mobile device according to claim 11, wherein the International Mobile Equipment Identifier of the SIM is used as the bank card account number.
